(19) United States
(12) Patent Application Publication
(10) Pub. No.: US 2015/0326604 A1
(43) Pub. Date: Nov. 12, 2015

(54) RULES BASED MONITORING AND INTRUSION DETECTION SYSTEM

(71) Applicant: POPO TECHNOLOGIES, INC., Miami, FL (US)

(72) Inventor: George Perera, Miami, FL (US)

(73) Assignee: POPO TECHNOLOGIES, INC., Miami, FL (US)

(21) Appl. No.: 14/707,780

(22) Filed: May 8, 2015

Related U.S. Application Data
(60) Provisional application No. 61/990,517, filed on May 8, 2014.

(51) Int. Cl. H04L 29/06

(52) U.S. Cl. CPC H04L 63/1441; H04L 63/1416

(57) ABSTRACT

The present invention is a rules-based monitoring and intrusion detection system that comprises three core components in a data network: a client electronic device in the form of a smart phone, tablet, or other electronic device; a mobile app gateway; and a web server. The system is initiated with an electronic request by a client to receive monitoring of their electronic device. The request is sent through a mobile application gateway and received by a web server. The web server responds to this request by sending a graphical user interface to the client's electronic device, with which the client may be able to configure certain settings for monitoring. The settings are in the form of rules, which in response to certain events, may trigger alarms in the intrusion detection software. The web server then receives these rules and compiles monitoring software for installation on the client's electronic device. Once activated, this software continuously monitors the client's electronic device and compares certain events with the programmed rules. Upon finding a matching event and rule, the monitoring software sends a communication to the web server and the web server then issues a command or sends a communication, depending on and in accordance with the user-defined rules. This system can be used to better secure the sensitive data stored on a client's electronic device in the event of theft, hacking, or misplacement.

### CROSS-REFERENCE TO RELATED APPLICATIONS

This application claims the benefit of U.S. Provisional Patent Application No. 61/990,517, filed on May 8, 2014, which is incorporated herein by reference.

### STATEMENT REGARDING FEDERALLY SPONSORED RESEARCH OR DEVELOPMENT

Not applicable.

### FIELD OF THE INVENTION

This invention relates generally to the field of intrusion detection, and more particularly, to a rules-based monitoring and intrusion detection system for client devices.

### BACKGROUND

By conservative estimates, there are over six billion mobile phones in use throughout the world. The technology for mobile phones is increasing at a rapid rate and consumers are eager to avail themselves of the newest bells and whistles in the form of apps for their smartphones. From a recent PewResearch Internet Project “Mobile Technology Fact Sheet” updated in January 2014, we have the following statistics: a) “91% of American adults have a cell phone;” b) “55% of American adults have a smartphone;” and c) “29% of cell owners describe their cell phone as ‘something they can't live without.’”

It is no wonder that a culture of cellphone dependence has evolved when you consider that today's smartphones combine the functions of an address book, a messaging system, a camera, an e-book reader, a photo album, GPS, navigation system, MP3 player, Web browser, and, of course, a telephone. If you lose your phone, chances are you've lost your contacts, your photos, music, appointments and maybe even some books and videos, to name a few. Solutions have been implemented that assist in recovering a lost or stolen phone. For example, “tracking” is offered on some devices (for a fee) that lets the user track the location of his/her phone through an on-line site. This solution is adequate for locating a device, but does not prohibit anyone from stealing the device.

Because smartphones are equipped with technology similar to that found in a personal computer, smartphones are also subject to virus, spyware, and malware intrusions. Known solutions for malware protection offer anti-viral apps that can be activated to recognize and thwart viruses based on signatures. These security measures work by scanning apps once they are loaded onto the phone. However, known anti-virus software for mobile devices, such as Google's Bouncer™, are limited to scanning loaded apps and do not offer protection from theft or misuse. Additionally, some anti-virus and anti-malware software can themselves be considered spyware.

What is needed is a comprehensive real-time monitoring and intrusion detection package that combines malware protection and theft protection for mobile devices. However, a package of this scope places a burdensome computational load on a mobile device, which is limited by its size.

### SUMMARY

The present invention is directed to a rules-based monitoring and intrusion detection system that solves the shortcomings of the known art.

Definition of Terms.

accelerometer—an instrument for measuring acceleration

apps—applications

e-book—digital book

GPS—global positioning system

LAMP—a Web application development and deployment tool. LAMP is an acronym for “Linux” “Apache Web Server” “MySQL database” “Perl, Python or PHP”

MP3—digital audio, music player

smartphone—phone that runs computer applications

### BRIEF DESCRIPTION OF THE DRAWINGS

These and other features, aspects and advantages of embodiments of the present invention will become better understood with regard to the following description, appended claims, and accompanying drawings where:

FIG. 1 shows an exemplary simplified depiction of an information processing system in which embodiments of the present invention can be implemented;

FIG. 2 is a flowchart of the setup process for real-time monitoring and intrusion detection, in accordance with an embodiment of the present invention;

FIG. 3 is a flowchart of the real-time monitoring from the perspective of the client device, in accordance with an embodiment of the present invention;

FIG. 4 is a flowchart of the real-time monitoring from the perspective of the server, in accordance with an embodiment of the present invention;

FIG. 5 shows an example of the interface for activating the real-time monitoring and intrusion detection, in accordance with an embodiment of the present invention;

FIG. 6 shows a simplified block diagram of the hardware components required for implementing the rules-based monitoring and intrusion detection, according to an embodiment of the present invention; and

FIG. 7 shows an exemplary illustration of the service status screen of the user interface of FIG. 5, according to an embodiment of the present invention.

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

We discuss an integrated method, system, and service for monitoring and thwarting intrusion on client devices. Customizable rules trigger appropriate responses on a server and possibly on the device itself when a suspicious event is detected on the device. This method improves upon known solutions to smartphone monitoring and intrusion detection in that the computational burden is placed on a server, not on the device itself, which is constrained by limited storage, memory and computational resources, as well as battery power. A user can subscribe to the service and select monitoring rules appropriate for the user's device.

Monitoring and Intrusion Detection System.

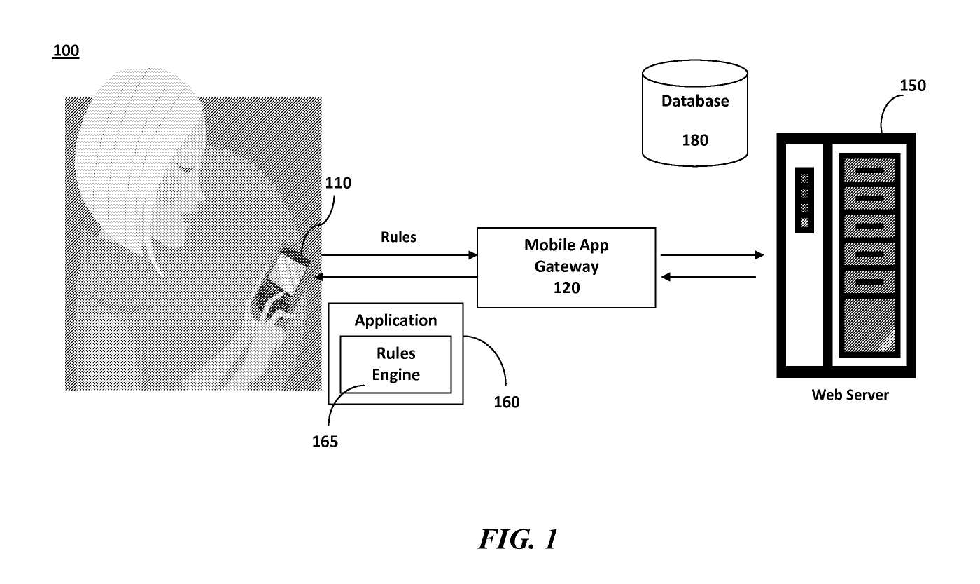

Referring now to the drawings in general and to FIG. 1 in particular, there is shown a simplified illustration of an information processing system 100 in which embodiments of the present invention can be implemented. In this exemplary embodiment, the client device 110 is represented as a smartphone because of its widespread use and familiarity; however, one with knowledge in the art will appreciate that a client device 110 can include, inter alia, a tablet computer, a laptop, a desktop computer, or a mobile phone.

In this embodiment, a user communicates with a Web Server 150 to identify the device to be monitored and set up a real-time monitoring and intrusion detection account for that device 110. Communication with the Server 150 can be enabled by a Mobile App Gateway 120. The Server 150 then generates an application 160 with an embedded simple rules engine 165 programmed with the user's selections. The Server 150 may need to access a database 180 or service for IP address translation, location coordinates, and device capabilities. The server 150 then makes this application 160 available to the client device 110 for download. Once the app 160 is loaded onto the client device 110, the user can activate/de-activate the monitoring.

Web Server.

The Server 150 is configured with software such as LAMP-based applications to enable the client to register, configure, load, pay, and generally manage the rules-based monitoring account. The server application supports e-commerce (credit cards and e-check) transactions and automated billing. All e-commerce functions are protected by a certificate and are located behind a password-protected firewall.

The Server 150 can independently collect information about the device 110 and its capabilities in order to configure the rules appropriate for the device. For example:

a) for a device 110 with GPS functionality, a rule can specify the trigger event “when movement occurs beyond the currently recorded location”

b) for a device 110 without GPS functionality, a rule can specify the trigger event “when the translated IP address changes to a specific factor such as distance (postal code), different ISP, and or from the last known stored IP address”

c) for a device 110 with an accelerometer, a rule can specify the trigger event when defined movement (force) occurs within 0.2 seconds, measured as X-axis speed, Y-axis speed

Using known methodology for tracking devices, the Server 150 can derive the exact location of the device 110 and determine if movement of the device 110 has occurred. In one embodiment of the present invention, the Server 150 automatically records the location of the device 110 when monitoring is activated by the user. In another embodiment of the present invention, a “kill switch” rule can be specified such that the device 110 becomes inoperable if the device 110 is stolen. With the “kill switch” feature enabled, the Server 150 will render the device 110 inoperable and erase all data on the device 110 in the event the device is stolen and/or leaves the set proximity of the owner. This feature can also be triggered by the owner via account log in as well.

User Interface.

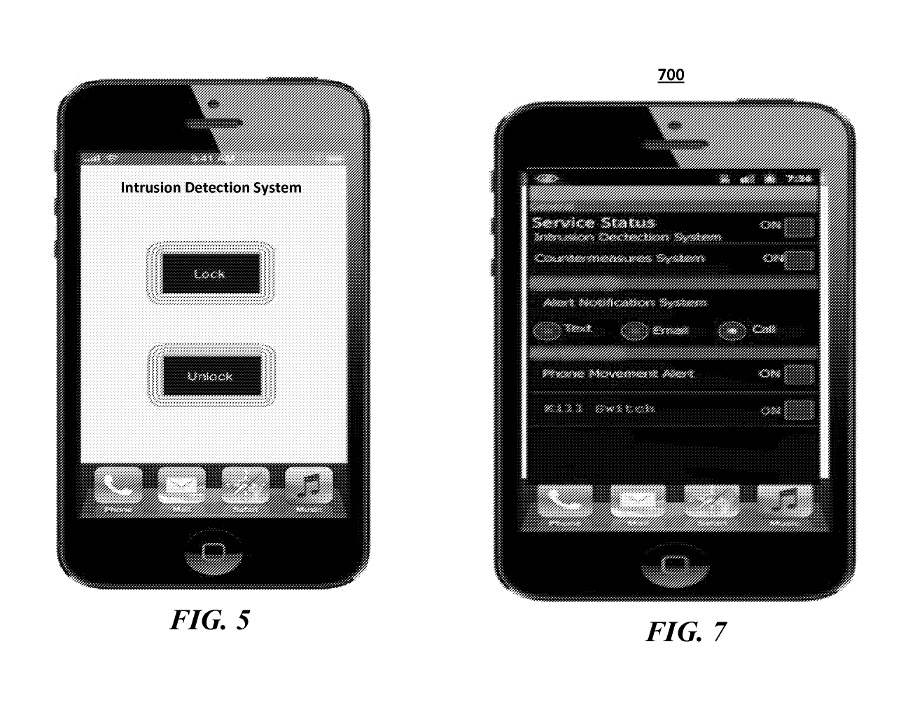

The Server 150 generates a graphical user interface featuring easy-to-navigate screens, using pages programmed in, for example, HTML5/CSS3/Javascript3 on the front-end. The back-end uses LAMP with PHP 5.x and MySQL running on a Centos 6.x Server configuration. Referring now to FIGS. 5 and 7, there are shown example screens of the user interface for the intrusion detection system, according to an embodiment of the present invention. By navigating the easy-to-use graphical user interface, the user is directed to select monitoring rules tailored for that specific device 110. A rule expresses a trigger/response such as: “If Device A leaves its current location (trigger), call this number (response).” FIG. 7 shows the Service Status screen 700 of the user interface. The service status is displayed, as well as the type of alert selected by the user. Optional features, such as a Phone Movement Alert and a Kill Switch are also shown.

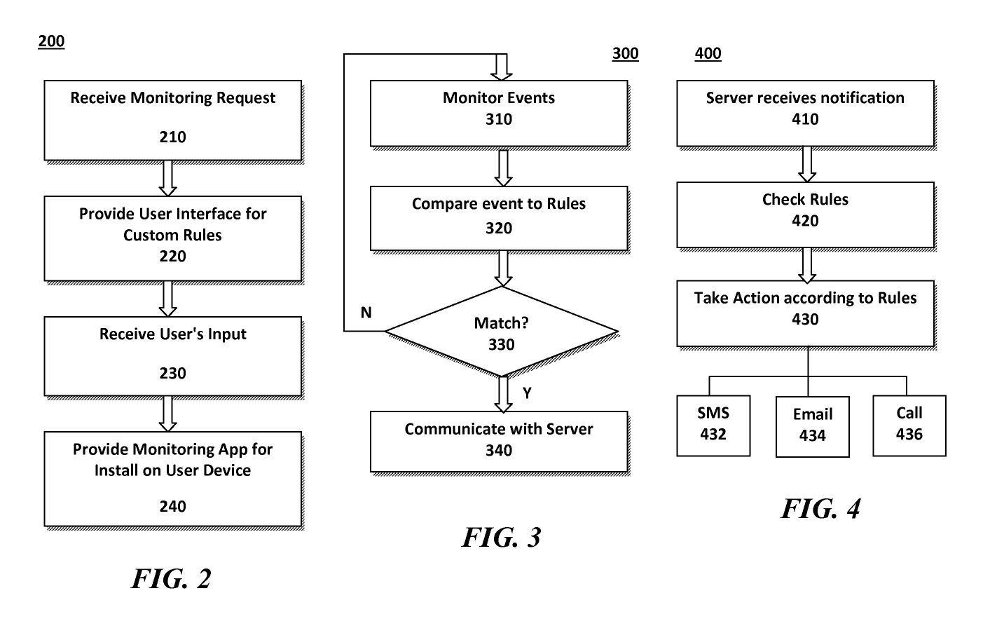

Referring now to FIG. 2, there is shown a high-level flowchart 200 of a method for rules-based monitoring and intrusion detection, according to an embodiment of the present invention. In step 210 the Web Server 150 receives a request for monitoring a device 110. In step 220, responsive to receiving the request, the Web Server 150 provides a graphical user interface (GUI) where the user can easily set up monitoring rules, specifying trigger events and their associated responses. The user also identifies the device 110 to be monitored. Once the user input is received and validated at the Web Server 150 in step 230, the Server 150 provides the monitoring application 160 for loading onto the client device 110. The application 160 can be downloaded from a website, or loaded from a non-transitory computer storage medium.

Referring now to FIG. 3 there is shown a flowchart 300 of the real-time monitoring, according to an embodiment of the present invention. Once the application 160 is activated on the device 110, it will continuously monitor events until de-activated, in step 310. Examples of events are: movement of the device 110, movement of the device 110 past a boundary, malware, intrusion detection, hacking, other unusual activity and theft of data.

In step 320 the device 110 receives an indication that an event has occurred. The event can be detected by monitoring the device's 110 WiFi and TCP connections, as well as detecting unusual activity. Some examples of unusual activity include, but are not limited to, port probing, file access attempts, configuration monitoring, system call monitoring, data exfiltration monitoring, and application and library lists. Once the event has been detected, the simple rules engine 165 compares the event to the list of events pre-selected by the user. If the event is a match for a trigger event specified in the rules set-up in step 330, then the device 110 notifies the Server 150 in step 340 and the Server 150 then takes the action associated with the trigger event. Some examples of pre-defined actions triggered by events are: notifying the client by text message, email, or telephone to a specified number.

Referring now to FIG. 4, there is shown a flowchart 400 of the server-side processing for rules-based monitoring and intrusion detection, according to an embodiment of the present invention. The Server 150 receives notification of a trigger event from the client device 110 in step 410. The notification specifies an identifier for the device 110 and the event that triggered the notification. Using this information, the Server 150 accesses the pre-defined instructions entered by the client in step 420 and initiates the appropriate action according to those instructions in step 430. The instructions can include any of several actions, such as send an SMS (Short Message Service) 432, send an email 434, call a specified phone number 436, or de-activate the device 110. An event may trigger more than one action. For example, the user can specify that an e-mail, a text message, and a phone call are all to be initiated if the device 110 leaves its present location.

FIG. 5 shows an exemplary screen 500 for activating/de-activating the rules-based monitoring and intrusion detection, according to an embodiment of the present invention. The user can easily turn the monitoring on or off via a password that is also stored by the Server 150 on the user's online account.

### Hardware Embodiment

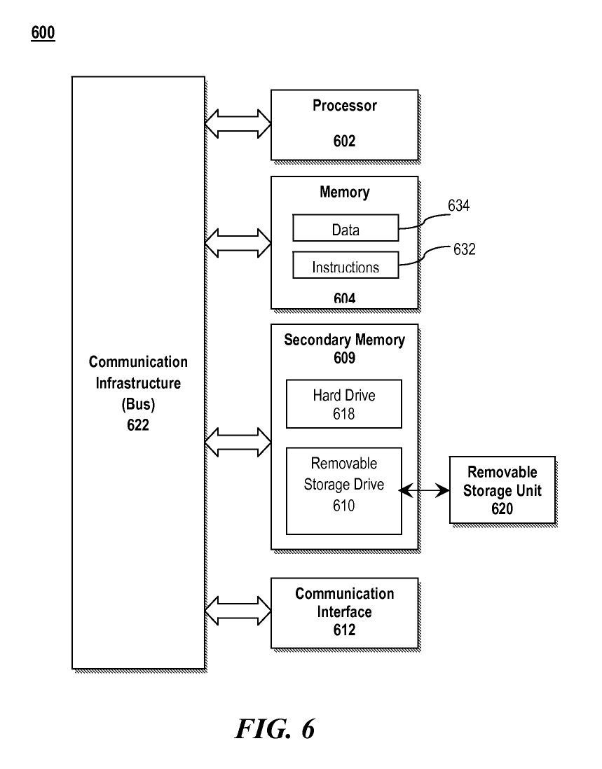

Referring now to FIG. 6, there is provided a simplified pictorial illustration of the hardware requirements for implementing rules-based monitoring and intrusion detection, in which the present disclosure may be implemented. For purposes of this invention, computer system 600 may represent any type of computer, information processing system or other programmable electronic device, including a client computer, a server computer, a portable computer, an embedded controller, a personal digital assistant, a Cloud computing device, and so on. The computer system 600 may be a stand-alone device or networked into a larger system. Computer system 600, illustrated for exemplary purposes as a mobile computing device, is in communication with other networked computing devices (not shown). As will be appreciated by those of ordinary skill in the art, a network may be embodied using conventional networking technologies and may include one or more of the following: local area networks, wide area networks, intranets, public Internet and the like.

Throughout the description herein, an embodiment of the invention is illustrated with aspects of the invention embodied solely on computer system 600. As will be appreciated by those of ordinary skill in the art, aspects of the invention may be distributed amongst one or more computing devices which interact with computer system 600 via one or more data networks such as, for example, the Internet. However, for ease of understanding, aspects of the invention have been embodied in a single computing device—computer system 600.

Computer system 600 includes inter alia processing device 602, which communicates with an input/output subsystem 606, memory 604, and storage 610. The processor device 602 is operably coupled with a communication infrastructure 622 (e.g., a communications bus, cross-over bar, or network). The processor device 602 may be a general or special purpose microprocessor operating under control of computer program instructions 632 executed from memory 604 on program data 634. The processor 602 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 604 may be partitioned or otherwise mapped to reflect the boundaries of the various memory subcomponents. Memory 604 may include both volatile and persistent memory for the storage of: operational instructions 632 for execution by CPU 602, data registers, application storage and the like. Memory 604 can include a combination of random access memory (RAM), read only memory (ROM) and persistent memory such as that provided by a hard disk drive 618 in secondary memory 609. The computer instructions/applications that are stored in memory 604 are executed by processor 602. The computer instructions/applications 632 and program data 634 can also be stored in hard disk drive 618 for execution by processor device 602.

The computer system 600 may also include a removable storage drive 610, representing a floppy disk drive, a magnetic tape drive, an optical disk drive, and the like. The removable storage drive 610 reads from and/or writes to a removable storage unit 620 in a manner well known to those having ordinary skill in the art. Removable storage unit 620, represents a floppy disk, a compact disc, magnetic tape, optical disk, CD-ROM, DVD-ROM, etc. which is read by and written to by removable storage drive 610. As will be appreciated, the removable storage unit 620 includes a non-transitory computer readable medium having stored therein computer software and/or data.

The computer system 600 may also include a communications interface 612. Communications interface 612 allows software and data to be transferred between the computer system and external devices. Examples of communications interface 612 may include a modem, a network interface (such as an Ethernet card), a communications port, a PCMCIA slot and card, etc. Software and data transferred via communications interface 612 are in the form of signals which may be, for example, electronic, electromagnetic, optical, or other signals capable of being received by communications interface 612.

In this document, the terms “computer program medium,” “computer usable medium,” and “computer readable medium” are used to generally refer to both transitory and non-transitory media such as main memory 604, removable storage drive 620, a hard disk installed in hard disk drive 618. These computer program products are means for providing software to the computer system 610. The computer readable medium 620 allows the computer system 600 to read data, instructions, messages or message packets, and other computer readable information from the computer readable medium 620.

In light of the foregoing description and accompanying disclosures, it should be recognized that embodiments in accordance with the present invention can be realized in numerous configurations contemplated to be within the scope and spirit of the invention. Additionally, the description above is intended by way of example only and is not intended to limit the present invention in any way, except as set forth in the claims recited below.

1. An intrusion detection system comprising:
a data network;
an electronic client device, which is operably connected as a first node on said data network;
a mobile application gateway, which is operably connected as a second node on said data network; and
a web server, which is operably connected as a third node on said data network.

2. The intrusion detection system of claim 1 wherein said web server is connected, via data network, to a database of protocols.

3. An intrusion detection process to be executed on a client electronic device, the process comprising the steps of:
providing a client electronic device configured with a mobile application gateway;
sending by the client electronic device, via the mobile application gateway, a request to a web server;
receiving onto said client electronic device a user interface;
inputting a desired set of rules, triggers, and alarms for detection into said user interface;
receiving onto said client electronic device, a monitoring software for installation on said client electronic device;
installing said monitoring software on said client electronic device; and sending, via said installed monitoring software, a communication to said web server if a monitored event matches any one of said set of rules, triggers, and alarms.

4. The intrusion detection process of claim 3, wherein said monitoring software is capable of monitoring events and continuously comparing said events to said set of rules, triggers, and alarms.

5. (canceled)

6. An intrusion detection process to be executed on a specially-configured web server, the process comprising the steps of:
receiving a request from a client electronic device, via a mobile application gateway, to receive real-time monitoring and intrusion detection;
sending, to said client electronic device, a user interface;
receiving, from said client device, a set of rules, triggers, and alarms for detection via said user interface;
compiling a monitoring software for installation on said client electronic device;
sending said monitoring software for download onto client electronic device;
awaiting a communication from said client electronic device if a monitored event matches any one of said set of rules, triggers, and alarms;
receiving said communication and checking a database for user-set appropriate command or appropriate action to said communication; and
sending said appropriate command to said client electronic device or taking said appropriate action.

7. The intrusion detection process of claim 6, wherein said user interface is configured for establishing a desired set of rules, triggers, and alarms for detection.

8. (canceled)

9. The intrusion detection process of claim 3, further comprising:
receiving a command from said web server to deactivate; and
deactivating said client electronic device.

10. The intrusion detection process of claim 4, further comprising:
receiving a command from said web server to deactivate; and
deactivating said client electronic device.

11. The intrusion detection process of claim 6, wherein said monitoring software is capable of continuously monitoring events and comparing said events to said set of rules, triggers, and alarms.

12. The intrusion detection process of claim 7, wherein said monitoring software is capable of continuously monitoring events and comparing said events to said set of rules, triggers, and alarms.
